(19) United States
(12) Patent Application Publication
(10) Pub. No.: US 2022/0188280 A1
(43) Pub. Date: Jun. 16, 2022

(54) MACHINE LEARNING BASED PROCESS AND QUALITY MONITORING SYSTEM

(71) Applicant: LIMITED LIABILIT COMPANY 'INLEKSYS' (LLC 'INLEKSYS"), Moskva (RU)

(72) Inventors: Vladimir Sergeevich BAKHOV, Moskva (RU); Dias Amankosovich ZHINALIEV, P. VNISSOK (RU)

(21) Appl. No.: 16/973,705

(22) PCT Filed: Jul. 2, 2020
(86) PCT No.: PCT/RU2020/050143

§ 371 Date: Dec. 9, 2020

(30) Foreign Application Priority Data
Jul. 4, 2019 (RU) 2019120791

(51) Int. Cl. G06F 16/215; G06F 16/2455; G06F 11/30; H04L 51/56

(52) U.S. Cl. CPC G06F 16/215; G06F 16/2455; G06N 20/00; H04L 51/36; G06F 11/3079

(57) ABSTRACT

This technical solution relates to big data computer processing field, in particular, to the system of automatic quality monitoring of data obtained from different sources in real time.

The technical result is improving quality and accuracy of analysis of data obtained from different sources in real time.

The computer-assisted system of automatic quality monitoring of data obtained from different sources in real time is claimed, comprising:
web application module, configured to add new monitoring sources to the system, configure advanced monitoring options, browse through event history and monitoring reports, and also visualize the detected data deviations;
integration connector module, configured to connect the system to different sources for obtaining data, and configured to transform these data into common internal format for further uniform processing;
machine learning module, which is self-learning to evaluate quality of data obtained in real time, during which:
receives from connectors the transformed data from different sources within the specified time period and saves them into total sample;
starts initialization of the saved sample monitoring by defining data change scales, while statistics are calculated for each sample indicator in accordance with a specific scale, and algorithm for check initialization is started for each indicator based on the calculated statistics;
after completion of learning the learned model parameters are saved in the database;
machine learning module uses the learned model parameters for subsequent monitoring new data received according to the specified schedule, while, the machine learning module is continuously relearned with new corrected data, if the current model improperly recognizes dependencies in new data, the module is fully relearned;
if some deviations are detected after monitoring of new data received, the notification aggregation module composes a text with errors;
information channel integration module sends the text with errors to corresponding users.

### FIELD OF THE INVENTION

This technical solution relates to big data computer processing field, in particular, to the system of automatic quality monitoring of data obtained from different sources in real time.

### BACKGROUND

Currently, there is a need for optimization of processes implemented in companies, factories, enterprises. A possibility of monitoring changes of key performance indicators—it is a recipe for success of any modern organization, and it also enables to predict and monitor changes of an organization's key performance indicators and respond to ongoing changes in proper time. Timely revealing of changes in organization activity would enable to influence on these changes and prepare for their consequences.

It is known in the prior art the solution US20160378830A1 (ADBA S A, publ. 2016-12-29), describing big data collection and analysis system consisting of: raw data obtained from different sources, adapters, which process raw data, main meta-database, where all settings and location of regional databases are relocated, analytical module, access interface, user interface. The main object of this solution is quick analysis of localized data followed by informing and possibly more deep analysis of several territories. It enables to respond quickly to different events: terroristic, market, geological, commercial, social, etc., saving money/time and responding to events near immediately. Provided that, this solution relates to tools for obtaining and comprehensive analysis of business data, however, it does not solve the problem of data quality control.

It is known in the prior art the solution EP3220267A1 (BUSINESS OBJECTS SOFTWARE LTD, publ. 2017-09-20), which describes add-in subsystem to distributed systems, such as Apache Spark, and optimizes data forecasting. Delegation of data processing operations is performed on a variable set of nodes. Optimization of predictive modeling is performed as on the client side as on the server side, e.g. Hadoop. However, this solution does not provide with a possibility of quality monitoring the data obtained from different sources in real time.

It is known in the prior art the solution U.S. Pat. No. 9,516,053B1 (SPLUNK INC, publ. 2016-12-06), which describes an approach to search for anomalous data in the network on the packet level to assess system security level: delay analysis or real time analysis at admin's discretion. This solution provides for computer networks analysis and monitoring. Anomalous spikes are visualized, and the system prompts that there is a spike/drop, that could indicate security breach, e.g. unauthorized access to the system. However, this solution does not provide with a possibility of quality monitoring the data obtained from different sources in real time.

It is known in the prior art the solution KR20180042865A (UPTAKE TECH INC, publ. 2018-04-26), which describes a platform for optimization of business processes inside the company, where the company-manufacturer could set up monitoring over suppliers, equipment and other companies. Each of the sensors informs the system about its state, and then certain rules could work. It is quite sophisticated configurable system focused on manufacturing process optimization. The main thing of this invention is data transfer control. If one node delays, all subsequent nodes and transport should be informed about it. It saves money and releases the reservation of excess resources. However, this solution does not provide with a possibility of quality monitoring the data obtained from different sources in real time.

### SUMMARY OF THE INVENTION

The technical problem to be solved by the claimed invention is creation of a platform system of automatic quality monitoring of data obtained from different sources in real time, which is characterized in the independent claim. Additional variants of this invention implementation are presented in the subclaims.

The technical result is improving quality and accuracy of analysis of data obtained from different sources in real time.

The additional technical result is detection of deviations in the obtained data and on line reporting the corresponding users about them before these deviations significantly affect manufacturing processes.

In the preferable embodiment the computer-assisted system of automatic quality monitoring of data obtained from different sources in real time is claimed, comprising:
web application module, configured to add new monitoring sources to the system, configure advanced monitoring options, browse through event history and monitoring reports, and also visualize the detected data deviations;
integration connector module, configured to connect the system to different sources for obtaining data, and configured to transform these data into common internal format for further uniform processing;
machine learning module, which is self-learning to evaluate quality of data obtained in real time, during which:
receives from connectors the transformed data from different sources within the specified time period and saves them into total sample;
starts initialization of the saved sample monitoring by defining data change scales, while statistics are calculated for each sample indicator in accordance with a specific scale, and algorithm for check initialization is started for each indicator based on the calculated statistics;
after completion of learning the learned model parameters are saved in the database;
machine learning module uses the learned model parameters for subsequent monitoring new data received according to the specified schedule, while, the machine learning module is continuously relearned with new corrected data, if the current model improperly recognizes dependencies in new data, the module is fully relearned;
if some deviations are detected after monitoring of new data received, the notification aggregation module composes a text with errors;
information channel integration module sends the text with errors to corresponding users.

In a particular embodiment there could be different data sources: Oracle Database, Hive, Kafka, PostgreSQL, Terradata, Prometheus, video and audio data flows.

In the other particular embodiment machine learning algorithm is implemented in Python.

In the other particular embodiment, the information channels could be: SMS channel, e-mail, Jira, Trello, Telegram channel.

### DESCRIPTION OF THE DRAWINGS

Implementation of the invention will be further described in accordance with the attached drawings, which are presented to clarify the invention chief matter and by no means limit the field of the invention. The following drawings are attached to the application:

FIG. 1 illustrates a computer-assisted system of automatic data quality monitoring;

FIG. 2 illustrates a diagram of test battery results with different volumes and sample representativeness;

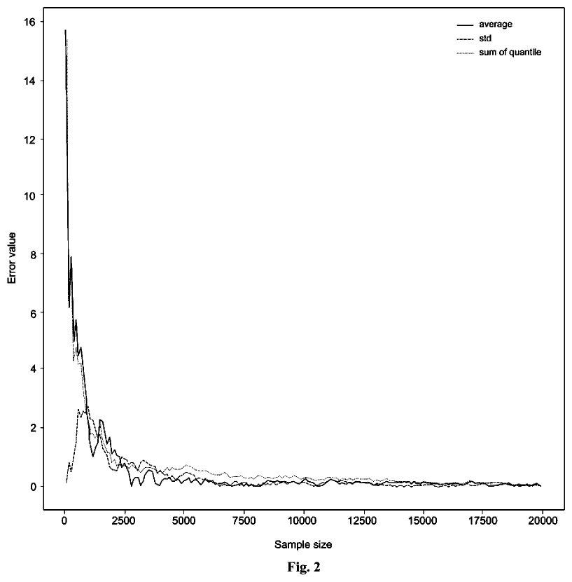

FIG. 3 illustrates a graph of sample size function;

FIG. 4 illustrates measurement scale determination algorithm;

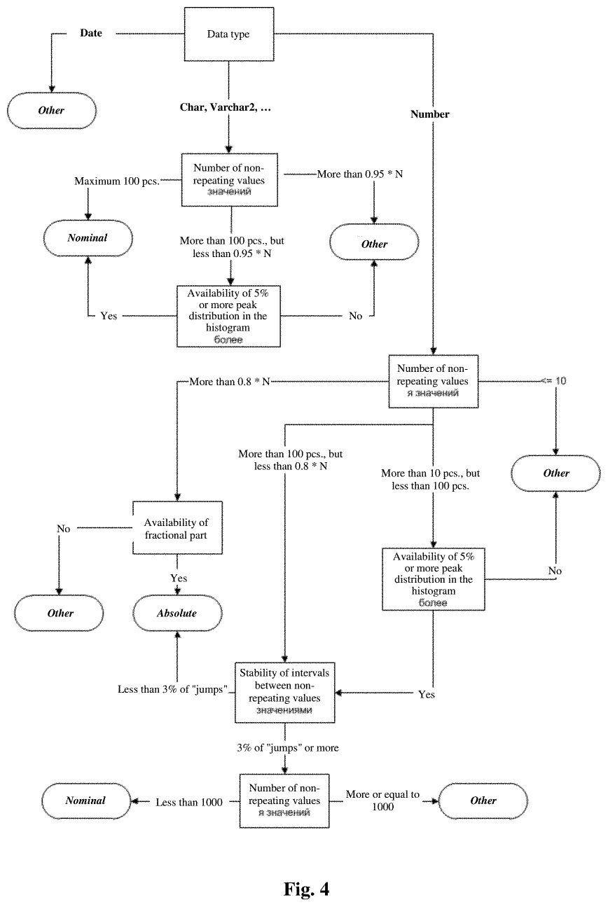

FIG. 5 illustrates the example of the computer device schematic diagram.

### DETAILED DESCRIPTION OF THE INVENTION

Numerous implementation details intended to ensure clear understanding of this invention are listed in the detailed description of the invention implementation given next. However, it is obvious to a person skilled in the art how to use this invention as with the given implementation details as without them. In other cases, the well-known methods, procedures and components have not been described in detail so as not to obscure the present invention.

Besides, it will be clear from the given explanation that the invention is not limited to the given implementation. Numerous possible modifications, changes, variations and replacements retaining the chief matter and form of this invention will be obvious to persons skilled in the art.

The claimed solution is implemented on high availability and fault-tolerant platform and is characterized by ease of setup, use, administering and monitoring of work.

This invention is intended to provide a computer-assisted system of automatic quality monitoring of data obtained from different sources in real time.

Data quality is a criterion defining data completeness, accuracy, actuality and possibility of their interpreting. Data could be of high and low quality. High quality data are complete, accurate, actual interpretable data. Such data ensure obtaining qualitative result: knowledge able to support decision-making process.

Low quality data are so called dirty data. Dirty data could be caused by different reasons, such as data input error, use of other presentation formats or measurement units, non-conformity with standards, lack of timely updating, unsuccessful updating all data copies, unsuccessful delete of duplicate records, etc.

The claimed solution provides the enterprises with such necessary functions as:
working with big and flow data in real time;
connectors to a variety of modern data sources (including Hadoop, working with audio and video data);
user notification about significant deviations via different channels;
possibility of using the system as cloud service;
incident management functionality.

Flow data are input at high rates and quickly accumulated in big volumes. Maximum benefit could be derived from such data only in case, if they are collected and analyzed in real time.

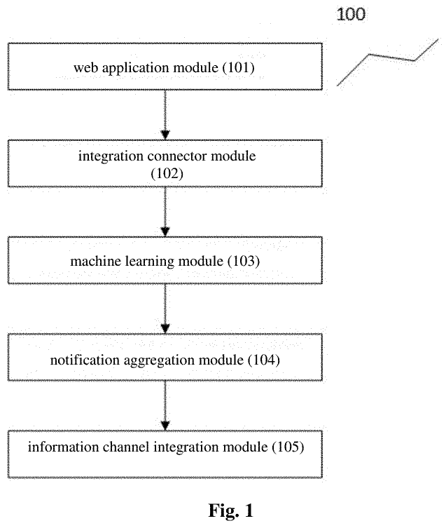

As detailed below in FIG. 1, the claimed computer-assisted system of automatic quality monitoring of data obtained from different sources in real time (100) includes the following set of the main modules:

web application module (101);
integration connector module (102);
machine learning module (103);
notification aggregation module (104);
information channel integration module (105).

Modern approach to use of microservice architecture is applied at development of system modules.

Prior to start system operation, the first step is performed: it is necessary to determine what namely sources store the data to be included into the claimed system, i.e. select external data sources. Such sources could be, e.g. Oracle Database, Hive, Apache Kafka, Cassandra, Sqoop, PostgreSQL, Terradata, Prometheus and any other sources. Also Apache nifi is installed as universal ETL tool with user-friendly graphical interface.

Working with multimedia data (audio and video) is also implemented. Main data labels are defined using machine learning models (neural networks, Markov chain-based models, different classifiers). For example, quantity of people per time unit in video flow or news subject in RSS News. Calculated statistics is defined by a model selected at generation of ETL process. Therefore, multimedia data could be converted into a structured fashion and used for monitoring data or other needs.

The above examples of sources are not limited to the given implementation, since they are constantly extended.

The second step: selection of monitoring object. Selection of tables/collections in database. One monitoring—one table, one database object (in case of flow data there could be several objects). All possible variants are pulled in automatically.

Monitoring fields are selected—selection of fields in a table/collection. Three types are available:

Date—indicator, upon which time data are aggregated. There could be maximum one indicator.

Grouping of indicators—indicator, upon which data are grouped. Any quantity could be selected.

Monitoring indicators—indicators which are analyzed by the system. It is possible to select all indicators using “Select All” button.

Besides, period of data input from sources is selected, and also name and description are specified.

Uploading could be performed after a specified time interval (day, week, months or quarter). In some cases a possibility of unscheduled data extraction after certain business event is provided (acquisition of new business, opening of a branch, arrival of big batch of goods).

Monitoring check interval also could be set up in the monitoring schedule. Time should be selected on the assumption that new data are already available in the source.

Setting of warning messages form is also performed; such information channels could be: SMS channel, e-mail, Jira, Trello, Telegram channel.

The above settings are performed in the web application module (101), which implements a possibility of system control by simple and user-friendly interface.

Besides, the web application module (101) is configured to add new monitoring sources to the system, configure advanced monitoring options, browse through event history and monitoring reports, and also visualize the detected data deviations.

When adding new sources, the system operation is not disturbed.

### Primary Data Processing

After connection of the integration connector module (102) to different sources in real time the process of data uploading is started. Data sample size is defined automatically by the random sample formula, developed during big amount of tests for statistical representativeness in terms of many parameters regardless of data distribution type.

Simple random sample formula is given below:

$$n = \frac{{t}^{2} * {σ}^{2} * N}{{t}^{2} * {σ}^{2} + {Δ}^{2} * N}$$

where,
t—t statistics value for selected significance level
σ—standard deviation of experimental variable
Δ—margin of sampling error
N—general population size.

However, this family formulas manipulate one variable statistics and calculate size of a representative sample for experimental parameter. Big amount of tests for defining sampling function and this function parameters was carried out to define sample size regardless of parameters quantity and their distribution types. Indicators of average value change, standard deviation and modal amount of quantiles difference (from 10% to 90% quantile) were take as main KPI of sample quality.

$$average = \frac{{\sum }_{i = 1}^{n} \frac{\overline{\vert ( {x}_{ι}} - x ) \vert}{x}}{n}$$

x̅ₗ—average value of sample i-th indicator
x—average value of general population i-th indicator
n—number of indicators

$$std = \frac{{\sum }_{i = 1}^{n} \frac{\overline{\vert ( σ} - σ ) \vert}{σ}}{n}$$

σ̅ₗ—standard deviation of sample i-th indicator
σ—standard deviation of general population i-th indicator
n—number of indicators

$$sum of quantile = \frac{{\sum }_{j = 1}^{n} {Q}_{j}}{n}$$

Q—relative deviation of quantiles from 10% to 90% in increments of 10%.

$$Q = \frac{{\sum }_{i = 1}^{9} \frac{\overline{\vert ( {q}_{ι}} - {q}_{i} ) \vert}{{q}_{i}}}{9}$$

q̅ₗ—i-th quantile of sampling population indicator (i is changed within 10%-90% in increments of 10%)
qᵢ—i-th quantile of general population indicator
n—number of indicators

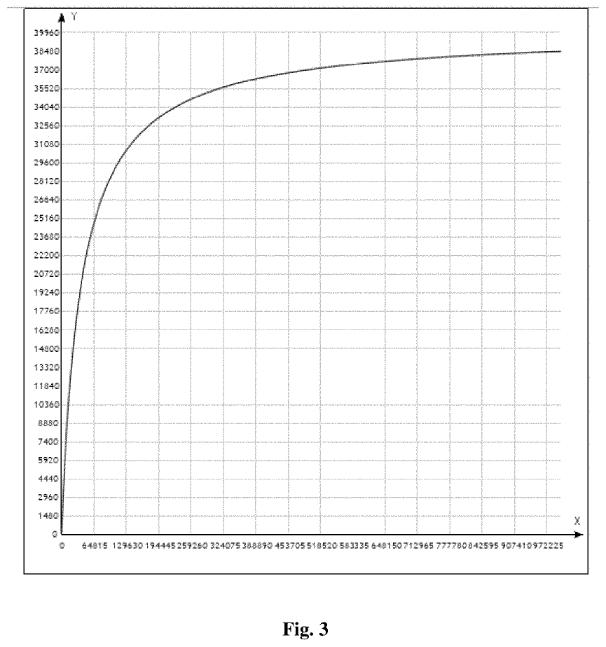

On the basis of graphical analysis (FIG. 3) and test results the following sample size function has been defined:

$$y ( x ) = \frac{1}{{( \frac{1}{200} )}^{2} + \frac{1}{x}} .$$

Initial data are located in heterogeneous sources of a wide variety of types and formats, since they are generated in different applications, and, besides, they could use different coding, while they should be transformed into universal format supported by the claimed system to solve analysis and monitoring tasks.

Therefore, the integration connector module (102) transforms the obtained data into common internal format for further uniform processing.

The transformed data from different sources are transferred to the machine learning module (103), which saves the obtained data in the total sample, and which is self-learning to evaluate quality of data obtained in real time on the basis of these data.

Depending on monitoring type the learning could last from several minutes to 14 days (in case of flow data). Correctness of historical data also effects on learning time. During learning the machine learning module analyzes data and identifies dependencies, permissible values, etc.

During learning it starts initialization of the saved sample monitoring by defining data change scales. Defining data change scales is one of binding system engines. Provided that, statistics are calculated for each sample indicator in accordance with a specific scale, and algorithm for check initialization is started for each indicator based on the calculated statistics.

Scale (measurement scale)—it is a semiotic system, for which a mapping (measurement operation), associating this or that scale element (value) with real objects (events), is specified. Formally, a tuple <X, φ, Y>, where X—multitude of real objects (events), φ—mapping, Y—multitude of semiotic system elements (values) (V. S. Anfilatov, A. A. Emelyanov, A. A. Kukushkin System Analysis in Management.—M. Finance and Statistics, 2002.—368 p.).

Measurement scale has several classifications. All data in the claimed solution will be divided onto 3 types:
nominal scale;
absolute scale;
and other (all the other types).

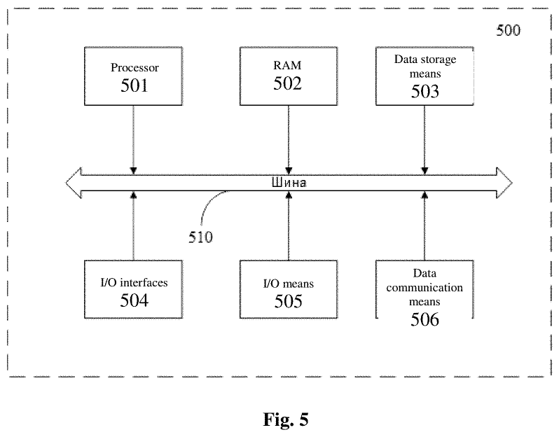

Since in the theory there is no clear algorithm of defining indicator scales, the proprietary algorithm has been developed, see FIG. 5.

Explanatory notes to the block diagram shown in FIG. 5 are given below:

Data type—type of data, which are built in the data source (source metadata).

N—number of records in the sample.

Availability of 5% or more peak distribution in the histogram—a proportion of each value in the whole array is calculated. If a proportion of at least one value exceeds 0.05, the attribute takes on the value “Yes”, otherwise, “No”.

Stability of intervals between non-repeating values—the indicator of data continuity indicating a proportion of sharp spikes of all population. Calculation algorithm:
1. Data distribution histogram is composed in the form of value: [count] table. Value—array value, count—value number in the array.
2. Additional indicator is calculated:

$$k = \frac{{value}_{current} - {value}_{previos}}{{N}_{current}}$$

value_{current}—histogram current value
valueₚᵣₑᵥᵢₒᵤₛ—histogram previous value
N_{current}—value_{current} number from histogram

We obtain the resulting value: [count, k]
3. Calculate two more indicators.

k_mean=average(kᵢ,kᵢ₋₁,kᵢ₋₂,kᵢ₋₃,kᵢ₋₄,kᵢ₋₅,kᵢ₋₆)

k_std=σ(kᵢ,kᵢ₋₁,kᵢ₋₂,kᵢ₋₃,kᵢ₋₄,kᵢ₋₅,kᵢ₋₆)

kᵢ—current value k

We obtain the resulting value: [count, k, k_mean, k_std]
4. Calculate continuity indicator.

$${i}_{continuous} = \{ \begin{matrix}1 , & abs ( {k}_{i} - {k}_{{mean}_{i - 1}} ) / 10 * {k}_{{std}_{i - 1}} \\ 0 , & otherwise\end{matrix}$$

We obtain the resulting value: [count, k, k_mean, k_std, i_continious]
5. Calculate average value i_continious of all the table.

Field occupancy in most of data store is at low level. In order to discriminate between real data and data filled in programmatically (e.g. with zeros, or NULL or some other value). For example, score (probability of any event for the object) is changed from 0 to 1. If this score cannot be calculated, it could be filled in as −99. Values −99 will substantially shift average value, data distribution type, etc.

The algorithm is applicable to all indicators with NUMBER data type. In order to define “default values” it is necessary to build up a histogram of data distribution in the latest available period without division into analytical units. NULL indicator value is not taken into account in the histogram.

“Default values” are defined as such values that:
are nonzero;
are at the histogram borders, i,e, correspond to maximum or minimum value;
histogram column height in them is in the list of three highest columns;
histogram column height in them exceeds the average height of histogram columns by minimum 3 standard deviations.

### Defining Big Fractions.

It is required to define the highest values by proportion among all the values from histogram. Later on, these values will be used for checking for saving proportion distribution. Proportion distribution monitoring enables to track filling in the most part of data.

Tracing indicators are selected in random samples at the latest periods. Number of periods for analysis is defined as follows:

N={7—daily periodicity; 5—weekly periodicity; 3—monthly periodicity; 3—yearly periodicity}.
1. In each of the latest periods: indicators with proportion more than 1% (more than 10% for absolute scales) are selected;
2. Arranging in proportion descending order;
3. Traveling from top to bottom a set of monitoring indicators is formed as follows:
3.0. algorithm initialization:
empty histogram;
individual proportion monitoring list is empty;
   3.1. check: does current value differ from the previous one more than 3 times?
   YES: 3.1.1. check: is histogram empty?
   YES: 3.1.1.1. add current value to the individual monitoring list, go to the next value by proportion size and make checking 3.1.
   NO: 3.1.1.2. add current value to histogram and complete the algorithm.
   NO: 3.1.2. add current value to histogram.
   3.1.3. check: are 5 values in histogram?
   YES: 3.1.3.1. complete the algorithm.
   NO: 3.1.3.2. go to the next value by proportion size and make checking 3.1.

Values, which have been in the analysis and at least once have been in the individual monitoring list, are included in the summary individual monitoring list.

Values, which have been in the histogram in all periods, are included into the summary histogram. If only 1 value is left in the histogram, it is required to form an individual monitoring for it and clear the histogram.

Values included into the histogram will be traced within one monitoring. Independent observations are formed for each value in the individual monitoring list.

Statistics calculation for each indicator is described below.

Statistics are calculated for each indicator in accordance with the defined scale. Different statistics are calculated:
indicator average value
indicator value proportions
number of null values
number of nonnull values
number of non-repeating values
correlation coefficient
number of zero values
number of positive and negative values
distribution tails
   Statistics calculation algorithm is single-pass and distributed.

Check and model initialization algorithm is started for each indicator on the basis of the calculated statistics. We obtain the resulting list of optimal checks for each indicator. Check list is formed on the basis of the extracted information about data. Primary focus is on checks disjointness, so that one and the same nature of error (e.g. null values proportion increased twice) is not defined two and more times.

### Check Initialization.

List of possible checks and their ON conditions was developed for comprehensive covering all possible system disorders. Checks are divided into logical and statistical.

### Logical Checks.

Checks of such type are used for checking a boolean condition for each field value, statistical checks are used for checking statistics (average value, number of non-repeating values, proportion of some field value, etc.).

Logical checks and their ON conditions, and also trigger conditions are given in Table 1 below.

TABLE 1

| | Data type | | | |
|---|---|---|---|---|
| | or scale | | | Eliminating |
| Check | conditions | Data conditions | New value check | checks |
| Availability of filled | no | Null values are less | All values are null | |
| values | | than 25% | in a new period | |
| No null values | no | No null values detected | Percent of null values in a | Availability |
| | | | new period exceeds max | of filled |
| | | | (MINR¹, 0.5) | values |
| Positiveness | NUMBER | No negative values detected | Percent of negative values in | |
| | | | a new period exceeds max | |
| | | | (MINR, 0.5) | |
| Negativeness | NUMBER | No positive values detected | Percent of positive values in a | |
| | | | new period exceeds max | |
| | | | (MINR, 0.5) | |
| Proportions | Absolute | No negative values detected | Percent of values beyond | |
| | | and maximum value <= 1 | (0.1) in a new period exceeds | |
| | | | max (MINR, 0.5) | |
| Percents | NUMBER | Minimum value > 1 and | Percent of values beyond | |
| | | maximum value <= 100 | (0.100) in new period | |
| | | | exceeds max (MINR, 0.5) | |
| Availability of | NUMBER | Null values proportion is | All indicator values are null | |
| nonnull values | | less than 25% | in a new period | |
| Availability of not | Absolute | Default values are available | All indicator values are | |
| “default” value | | Default values proportion is | default values in a new period | |
| | | less than 25% | | |
| Availability of | Absolute | Proportion of null, 0 and | In a new period all indicator | Availability of |
| significant values | | default values is less than | values are default values, 0 | nonnull values. |
| | | 25% in total | and NULL, and no one more | Availability of |
| | | | strict monitoring has been | filled values. |
| | | | triggered | Availability of |
| | | | | not “default” |
| | | | | value |

¹System disorder-moment of change in system behaviour.
²MINR-Sensitivity of sample statistics. $MINR = 100 * \frac{11 + \sqrt{117 - \frac{36}{n}}}{2 n + 18} ,$ where n - size of sampling population. MINR percent of objects is interpreted by the system as statistically significant group.

### Example

In order to enable checking for “Lack of data” it is necessary that there are no null values in the learning sample, and checking for “Availability of filled” is not ON. For the purpose of check triggering (error detection) it is necessary that percent of null values in a new period (new period sample) exceeds MINR and 0.5%. For example, if there are 10000 values in a new period, the system will classify the data as erroneous, if among 10000 values there are over 50 null values (MINR=0.1%->max(MINR, 0.5)=0.5->10000*0.5%=50).

Statistical checks.
Scope:

Check of lines number in the data source. It is required for data source filling monitoring. Checked statistics: number of records in the source for a period.
Trend:

Check of indicator average value. It is required for average value monitoring.

### Check ON Conditions:

Data type—number
There are more than 20% of initial data in the data array in the initialization period after elimination of default values, null and 0 values.

Checked statistics: indicator average value exclusive of default values, null and 0 values, and outliers.
Proportions: Check of proportion distribution. It is required for indicator value proportion monitoring.

### Check ON Conditions:

Indicator measurement scale is absolute or nominal
Tracking values are found (according to the proportion algorithm).

Checked statistics: number of non-repeating values.
Variability:

Check of number of non-repeating values. It is required for non-repeating values monitoring.

### Check ON Conditions:

Indicator measurement scale—absolute.
Assessment result of non-repeating value proportion in a sample is from 30% to 95%.

Checked statistics: number of non-repeating values.
Dependence:

Check of correlation dependence between indicators. The checking is used for monitoring the dependence between the fields. For example, if one field directly depends on the other ones, the model detects the dependence and warns about error, if the dependence is violated.

### Check ON Conditions:

Indicator measurement scale—absolute.
Pearson correlation coefficient is more than 0.5.

### Statistical Model Learning

History learning is started for each selected model and check. Learning period depends on selected model, indicator variability and available history. Let us see an example of learning for some checking. Let us assume that we need to built a model for clients average age checking in the bank client profile. Learning algorithm is as follows:

I. Accumulation of necessary data history. Let us assume that the client profile is recalculated every day, hence, we need minimum 14 days of history (i.e. 14 latest values of clients average age). Number of required periods is built in system parameters.

II. After accumulation of the required history (let us assume that we have obtained 14 average values) the process of defining optimal model is started. Time series is divided into test and control sample. Test sample is used for building different models (moving-average model, autoregressive model, linear model, regression tree, etc.). Control sample is used for calculation of each model error (root-mean-square error). Optimal model is selected by minimum error value.

III. If an error (MAPE) in the control sample exceeds 0.2, the model is considered to be insufficiently learned and we go back to the paragraph I (take the average age value 15 days before, etc.).

IV. When the model is defined, standard deviation of predicted and real value is calculated by control sample. Then, model sensitivity parameter is calculated:

$$k = MAX ( \frac{\vert {real}_{i} - {predict}_{i} \vert}{std} )$$

where,
realᵢ—real value in the control sample
predictᵢ—model value in the control sample
std—standard deviation of predicted and real value

V. The system records model parameters and predicted value for a new period. For example, we have obtained the resulting autoregressive model with the parameters (p=2, d=0, q=1), model sensitivity is 1.34, standard deviation is 0.4, and the prediction for the next day=41.8 years. When learning is completed, there is finish setting of model parameters and recording of all parameters in the system, and the learned model parameters are saved in the database. After that, the system is ready for operation and starts checking of new data according to the schedule.

On the date of the scheduled check: the system automatically starts checking of new data. Upon completion of checking—new graphs are plotted according to the obtained data. If the data obtained for all the time after generation of monitoring are less than Nmax: the data are added with the data used for initialization (learning).

### New Data Checking

Machine learning module (103) uses the learned model parameters for subsequent monitoring new data received according to the specified schedule, while, the machine learning module is continuously relearned with new corrected data, if the current model improperly recognizes dependencies in new data, the module is fully relearned.

Upon completion of history learning and recording all the parameters the checking of periods is started. According to the selected schedule the new data checking for correctness is started. New data are checked for compliance with a forecast. New value is considered to be correct, if it is within the range:

[predict−k*std; predict+k*std].

According to the above example, if client average age on a new day is within the range [41.8−1.34*0.4; 41.8+1.34*0.4]==[41.264; 42.336], the system will classify the new data as correct.

### User Error Notification

If some deviations are detected after monitoring of new data received, the notification aggregation module (104) composes a text with errors.

Information channel integration module (105) sends the text with errors to corresponding users. There are several methods of user error notification: sms, e-mail, trello, telegram, jira.

Notification on detected events enables users to respond to them immediately. Simultaneously, the solution saves data in processing environments, such as Hadoop, for further use and comparison with historical data, for predictive analytics.

Hadoop—open program framework for working with gigantic volumes of data, including implementation of MapReduce. MapReduce—parallel processing model for gigantic data sets in distributed systems implemented in Hadoop.

Results of all monitoring checks, including detected errors and warnings, are displayed in the history.

FIG. 5 illustrates schematic diagram of the computer device (500) providing data processing required for implementation of the claimed system of automatic quality monitoring of data obtained from different sources in real time.

In general, the computer device (500) comprises such components as: one or more processors (501), at least one memory (502), data storage means (503), input/output interfaces (504), input/output means (505), networking means (506).

The device processor (501) executes main computing operations, required for functioning the device (500) or functionality of one or more of its components. The processor (501) runs the required machine-readable commands, contained in the random-access memory (502).

The memory (502), typically, is in the form of RAM and comprises the necessary program logic ensuring the required functional.

The data storage means (503) could be in the form of HDD, SSD, RAID, networked storage, flash-memory, optical drives (CD, DVD, MD, Blue-Ray disks), etc. The means (503) enables to store different information, e.g. the above-mentioned files with user data sets, databases comprising records of time intervals measured for each user, user identifiers, etc. for a long time.

The interfaces (504) are the standard means for connection and operation of several devices, e.g. USB, RS232, RJ45, LPT, COM, HDMI, PS/2, Lightning, FireWire, etc.

Selection of interfaces (504) depends on the specific device (500), which could be a personal computer, mainframe, server cluster, thin client, etc.

Networking means (506) are selected from a device providing network data receiving and transfer, e.g. Ethernet-card, WLAN/Wi-Fi module, Bluetooth module, BLE module, NFC module, IrDa, RFID module, GSM modem, etc. Making use of the means (505) provides an arrangement of data exchange through wire or wireless data communication channel, e.g. WAN, PAN, LAN, Intranet, Internet, WLAN, WMAN or GSM.

The components of the device (500) are interconnected by the common data bus (510).

The application materials have represented the preferred embodiment of the claimed technical solution, which shall not be used as limiting the other particular embodiments, which are not beyond the claimed scope of protection and are obvious to persons skilled in the art.

1. The computer-assisted system of automatic quality monitoring of data obtained from different sources in real time is claimed, comprising:
web application module, configured to add new monitoring sources to the system, configure advanced monitoring options, browse through event history and monitoring reports, and also visualize the detected data deviations;
integration connector module, configured to connect the system to different sources for obtaining data, and configured to transform these data into common internal format for further uniform processing;
machine learning module, which is self-learning to evaluate quality of data obtained in real time, during which:
receives from connectors the transformed data from different sources within the specified time period and saves them into total sample;
starts initialization of the saved sample monitoring by defining data change scales, while statistics are calculated for each sample indicator in accordance with a specific scale, and algorithm for check initialization is started for each indicator based on the calculated statistics;
after completion of learning the learned model parameters are saved in the database;
machine learning module uses the learned model parameters for subsequent monitoring new data received according to the specified schedule, while, the machine learning module is continuously relearned with new corrected data, if the current model improperly recognizes dependencies in new data, the module is fully relearned;
if some deviations are detected after monitoring of new data received, the notification aggregation module composes a text with errors;
information channel integration module sends the text with errors to corresponding users.

2. The system of claim 1, characterized in that there could be different data sources: Oracle Database, Hive, Kafka, PostgreSQL, Terradata, Prometheus.

3. The system of claim 1, characterized in that machine learning algorithm is implemented in Python.

4. The system of claim 1, characterized in that information channels could be: SMS channel, e-mail, Jira, Trello, Telegram channel.
